(19) United States
(12) Patent Application Publication
(10) Pub. No.: US 2007/0202192 A1
(43) Pub. Date: Aug. 30, 2007

(54) Fungical Mixtures For Controlling Rice Pathogens

(75) Inventors: Jordi Tormo i Blasco, Weinheim (DE); Thomas Grote, Wachenheim (DE); Maria Scherer, Landau (DE); Reinhard Stierl, Kaohsiung County (TW); Siegfried Strathmann, Limburgerhof (DE); Ulrich Schofl, Bruhl (DE)

Correspondence Address: BIRCH STEWART KOLASCH & BIRCH, PO BOX 747, FALLS CHURCH, VA, 22040-0747, US

(73) Assignee: BASF AKTIENGESELLSCHAFT, LUDWIGSHAFEN (DE)

(21) Appl. No.: 10/579,396

(22) PCT Filed: Nov. 18, 2004
(86) PCT No.: PCT/EP04/13066

§ 371 Date: Apr. 27, 2007

(30) Foreign Application Priority Data
Nov. 27, 2003 (DE) 103 56 104.8
Mar. 15, 2004 (DE) 10 2004 012 753.0

(51) Int. Cl. A01N 57/18; A01N 43/90; A01N 59/26

(52) U.S. Cl. 424/601; 514/140; 514/259.31

(57) ABSTRACT

Fungicidal mixtures comprising, as active components,
1) the triazolopyrimidine derivative of the formula 1, 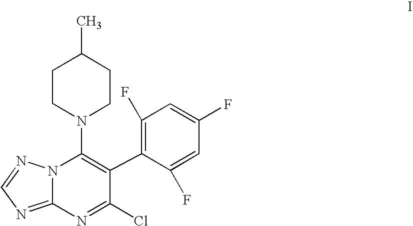 and
2) phosphorous acid H₃PO₃, its alkali metal or alkaline earth metal salts or derivatives releasing them II in a synergistically effective amount, methods for controlling harmful fungi using mixtures of the compound I with the compound II, the use of the compound I with the compound II for preparing such mixtures and compositions comprising these mixtures are described.

The present invention relates to fungicidal mixtures comprising, as active components,
1) the triazolopyrimidine derivative of the formula I, 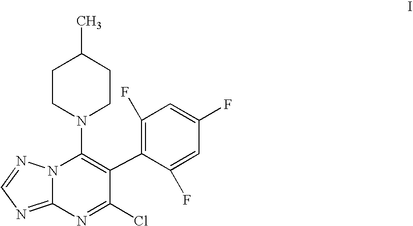
   and
2) phosphorous acid H₃PO₃,
   its alkali metal or alkaline earth metal salts or derivatives releasing them II
      in a synergistically effective amount.

Moreover, the invention relates to a method for controlling harmful fungi using mixtures of the compound I with the compound II and to the use of the compound I with the compound II for preparing such mixtures and compositions comprising these mixtures.

The compound 1,5-chloro-7-(4-methylpiperidin-1-yl)-6-(2,4,6-trifluorophenyl)-[1,2,4]triazolo[1,5-a]pyrimidine, its preparation and its action against harmful fungi are known from the literature (WO 98/46607).

Mixtures of triazolopyrimidines with other active compounds are generally known from EP-A 988 790 and U.S. Pat. No. 6,268,371.

The synergistic mixtures described in EP-A 988 790 are said to be fungicidally active against various diseases of cereals, fruit und vegetables, in particular mildew on wheat and barley or gray mold on apples. The mixtures known from U.S. Pat. No. 6,268,371 are described as being particularly suitable for use against diseases of rice.

Phosphorous acid is the actual effective degradation product of the commercially long-established active compounds ethyl phosphonate (common name: fosetyl) IIa and ethyl phosphonate aluminum salt (common name: fosetyl aluminum) II b.

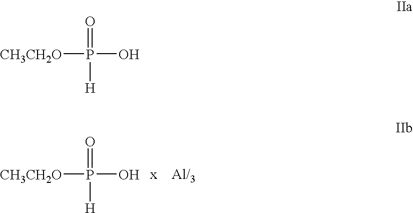

The preparation and the fungicidal action of the ester IIa and the corresponding aluminum salt IIb are known from the literature (FR 22 54 276).

It was an object of the present invention, with a view to effective control of harmful fungi at application rates which are as low as possible, to provide mixtures which, at a reduced total amount of active compounds applied, have improved action against harmful fungi (synergistic mixtures).

We have found that this object is achieved by the mixtures defined at the outset. Moreover, we have found that simultaneous, that is joint or separate, application of the compound I and the compound II or successive application of the compound I and the compound II allows better control of harmful fungi than is possible with the individual compounds.

The mixtures of the compound I and the compound II or the simultaneous (joint or separate) use of the compound I and the compound II are distinguished by an outstanding effectiveness against a broad spectrum of phytopathogenic fungi, especially from the classes of the Ascomycetes, Deuteromycetes, Oomycetes and Basidiomycetes. They can be used in crop protection as foliar and soil fungicides.

They are particularly important in the control of a multitude of fungi on various cultivated plants, such as bananas, cotton, vegetable species (for example cucumbers, beans and cucurbits), barley, grass, oats, coffee, potatoes, corn, fruit species, rice, rye, soya, tomatoes, grapevines, wheat, ornamental plants, sugar cane and a large number of seeds.

They are especially suitable for controlling the following phytopathogenic fungi: Blumeria graminis (powdery mildew) on cereals, Erysiphe cichoracearum and Sphaerotheca fuliginea on cucurbits, Podosphaera leucotricha on apples, Uncinula necator on grapevines, Puccinia species on cereals, Rhizoctonia species on cotton, rice and lawns, Ustilago species on cereals and sugar cane, Venturia inaequalis on apples, Bipolaris and Drechslera species on cereals, rice and lawns, Septoria nodorum on wheat, Botrytis cinerea on strawberries, vegetables, ornamental plants and grapevines, Mycosphaerella species on bananas, peanuts and cereals, Pseudocercosporella herpotrichoides on wheat and barley, Pyricularia oryzae on rice, Phytophthora infestans on potatoes and tomatoes, Pseudoperonospora species on cucurbits and hops, Plasmopara viticola on grapevines, Alternaria species on fruit and vegetables and also Fusarium and Verticillium species.

The mixtures of the invention are of particular importance for controlling harmful fungi on rice plants and seeds thereof, such as Bipolaris and Drechslera species, and also Pyricularia oryzae. They are particularly suitable for the control of brown spot of rice caused by Cochliobolus miyabeanus.

Rice pathogens are typically different from those in cereals or fruit. Pyricularia oryzae and Corticium sasakii (syn. Rhizoctonia solani) are the pathogens of the diseases most prevalent in rice plants. Rhizoctonia solani is the only pathogen of agricultural significance from the sub-class Agaricomycetidae. In contrast to most other fungi, this fungus attacks the plant not via spores but via a mycelium infection.

The mixtures of the invention can also be used in the protection of materials (e.g. the protection of wood), for example against Paecilomyces variotii.

When preparing the mixtures, it is preferred to employ the pure active compounds I and II, to which further active compounds against harmful fungi or against other pests, such as insects, arachnids or nematodes, or else herbicidal or growth-regulating active compounds or fertilizers can be added according to need.

Other suitable active compounds in the above sense are in particular active compounds selected from the following groups:
acylalanines, such as benalaxyl, metalaxyl, ofurace, oxadixyl,
amine derivates, such as aldimorph, dodemorph, fenpropimorph, fenpropidin, guazatine, iminoctadine, tridemorph,
anilinopyrimidines, such as pyrimethanil, mepanipyrim or cyprodinil,
antibiotics, such as cycloheximid, griseofulvin, kasugamycin, natamycin, polyoxin or streptomycin,
azoles, such as bitertanol, bromoconazole, cyproconazole, difenoconazole, dinitroconazole, enilconazole, epoxiconazole, fenbuconazole, fluquinconazole, flusilazole, flutriafol, hexaconazole, imazalil, ipconazole, metconazole, myclobutanil, penconazole, propiconazole, prochloraz, prothioconazole, simeconazole, tebuconazole, tetraconazole, triadimefon, triadimenol, triflumizole, triticonazole,
dicarboximides, such as myclozolin,
dithiocarbamates, such as ferbam, nabam, maneb, mancozeb, metam, metiram, propineb, polycarbamate, thiram, ziram, zineb,
heterocyclic compounds, such as anilazine, benomyl, boscalid, carbendazim, carboxin, oxycarboxin, cyazofamid, dazomet, dithianon, famoxadone, fenamidone, fenarimol, fuberidazole, flutolanil, furametpyr, isoprothiolan, mepronil, nuarimol, probenazole, pyroquilon, quinoxyfen, silthiofam, thiabendazole, thifluzamide, tiadinil, tricyclazole, triforine,
nitrophenyl derivatives, such as binapacryl, dinocap, dinobuton, nitrophthalisopropyl,
phenylpyrroles, such as fenpiclonil or fludioxonil,
sulfur,
other fungicides, such as acibenzolar-S-methyl, carpropamid, chlorothalonil, cyflufenamid, cymoxanil, dazomet, diclomezin, diclocymet, diethofencarb, edifenphos, ethaboxam, fenhexamid, fentin acetate, fenoxanil, ferimzone, fluazinam, fosetyl, fosetyl aluminum, iprovalicarb, hexachlorobenzene, metrafenon, methyl isothiocyanate, pencycuron, propamocarb, phthalide, toloclofos-methyl, quintozene, zoxamid,
strobilurins, such as azoxystrobin, dimoxystrobin, fluoxastrobin, kresoxim-methyl, metominostrobin, orysastrobin, pyraclostrobin or trifloxystrobin,
sulfenic acid derivatives, such as captafol, captan, dichlofluanid, folpet,
cinnamides and analogous compounds, such as dimethomorph, flumetover or flumorph.

In one embodiment of the mixtures according to the invention, a further fungicide III or two fungicides III and IV (as mentioned above) are added to the compounds I and II.

Particular preference is given to mixtures comprising, as active compound III, captafol, captan, diclofluanid, folpet, maneb, mancozeb, metivam, thiram or zineb.

Preference is given to mixtures comprising the compounds I and II, in particular IIb, which mixtures may, if desired, comprise a component III.

The compound I and the compound II can be applied simultaneously, that is jointly or separately, or in succession, the sequence, in the case of separate application, generally not having any effect on the result of the control measures.

The compound I and the compound II are usually applied in a weight ratio of from 100:1 to 1:100, preferably from 10:1 to 1:20, in particular from 5:1 to 1:10. The ratios mentioned above and the statements below refer in particular to the compound I and fosetyl aluminum IIb. If phosphorous acid II, its alkali metal or alkaline earth metal salts or fosetyl IIa are used, the amounts of component (2) may be reduced in accordance with the lower molecular weight.

Depending on the type of compound and the desired effect, the application rates of the mixtures according to the invention are from 5 g/ha to 2500 g/ha, preferably from 50 to 2000 g/ha, in particular from 50 to 1000 g/ha.

Correspondingly, the application rates for the compound I are generally from 1 to 1000 g/ha, preferably from 10 to 900 g/ha, in particular from 20 to 750 g/ha.

Correspondingly, the application rates for the compound IIb are generally from 1 to 2500 g/ha, preferably from 10 to 1000 g/ha, in particular from 20 to 750 g/ha.

In the treatment of seed, application rates of mixture are generally from 1 to 1000 g/100 kg of seed, preferably from 1 to 200 g/100 kg, in particular from 5 to 100 g/100 kg.

In the control of phytopathogenic harmful fungi, the separate or joint application of the compound I and the compound II or of the mixtures of the compound I and the compound II is carried out by spraying or dusting the seeds, the plants or the soil before or after sowing of the plants or before or after emergence of the plants. The compounds are preferably applied by spraying the leaves.

The mixtures according to the invention, or the compounds I and II, can be converted into the customary formulations, for example solutions, emulsions, suspensions, dusts, powders, pastes and granules. The use form depends on the particular intended purpose; in each case, it should ensure a fine and even distribution of the compound according to the invention.

The formulations are prepared in a known manner, for example by extending the active compound with solvents and/or carriers, if desired using emulsifiers and dispersants. Solvents/auxiliaries suitable for this purpose are essentially:
water, aromatic solvents (for example Solvesso products, xylene), paraffins (for example mineral oil fractions), alcohols (for example methanol, butanol, pentanol, benzyl alcohol), ketones (for example cyclohexanone, gamma-butyrolactone), pyrrolidones (NMP, NOP), acetates (glycol diacetate), glycols, fatty acid dimethylamides, fatty acids and fatty acid esters. In principle, solvent mixtures may also be used,
carriers such as ground natural minerals (for example kaolins, clays, talc, chalk) and ground synthetic minerals (for example highly disperse silica, silicates); emulsifiers such as nonionic and anionic emulsifiers (for example polyoxyethylene fatty alcohol ethers, alkylsulfonates and arylsulfonates) and dispersants such as lignosulfite waste liquors and methylcellulose.

Suitable surfactants used are alkali metal, alkaline earth metal and ammonium salts of lignosulfonic acid, naphthalenesulfonic acid, phenolsulfonic acid, dibutylnaphthalenesulfonic acid, alkylarylsulfonates, alkyl sulfates, alkylsulfonates, fatty alcohol sulfates, fatty acids and sulfated fatty alcohol glycol ethers, furthermore condensates of sulfonated naphthalene and naphthalene derivatives with formaldehyde, condensates of naphthalene or of naphthalenesulfonic acid with phenol and formaldehyde, polyoxyethylene octylphenyl ether, ethoxylated isooctylphenol, octylphenol, nonylphenol, alkylphenyl polyglycol ethers, tributylphenyl polyglycol ether, tristearylphenyl polyglycol ether, alkylaryl polyether alcohols, alcohol and fatty alcohol ethylene oxide condensates, ethoxylated castor oil, polyoxyethylene alkyl ethers, ethoxylated polyoxypropylene, lauryl alcohol polyglycol ether acetal, sorbitol esters, lignosulfite waste liquors and methylcellulose.

Substances which are suitable for the preparation of directly sprayable solutions, emulsions, pastes or oil dispersions are mineral oil fractions of medium to high boiling point, such as kerosene or diesel oil, furthermore coal tar oils and oils of vegetable or animal origin, aliphatic, cyclic and aromatic hydrocarbons, for example toluene, xylene, paraffin, tetrahydronaphthalene, alkylated naphthalenes or their derivatives, methanol, ethanol, propanol, butanol, cyclohexanol, cyclohexanone, isophorone, highly polar solvents, for example dimethyl sulfoxide, N-methylpyrrolidone and water.

Powders, materials for spreading and dustable products can be prepared by mixing or concomitantly grinding the active substances with a solid carrier.

Granules, for example coated granules, impregnated granules and homogeneous granules, can be prepared by binding the active compounds to solid carriers. Examples of solid carriers are mineral earths such as silica gels, silicates, talc, kaolin, attaclay, limestone, lime, chalk, bole, loess, clay, dolomite, diatomaceous earth, calcium sulfate, magnesium sulfate, magnesium oxide, ground synthetic materials, fertilizers, such as, for example, ammonium sulfate, ammonium phosphate, ammonium nitrate, ureas, and products of vegetable origin, such as cereal meal, tree bark meal, wood meal and nutshell meal, cellulose powders and other solid carriers.

In general, the formulations comprise from 0.01 to 95% by weight, preferably from 0.1 to 90% by weight, of the active compounds. The active compounds are employed in a purity of from 90% to 100%, preferably 95% to 100% (according to NMR spectrum).

The Following are Examples of Formulations: 1. Products for Dilution with Water

A) Water-Soluble Concentrates (SL)

10 parts by weight of the active compounds are dissolved in water or in a water-soluble solvent. As an alternative, wetters or other auxiliaries are added. The active compound dissolves upon dilution with water.

B) Dispersible Concentrates (DC)

20 parts by weight of the active compounds are dissolved in cyclohexanone with addition of a dispersant, for example polyvinylpyrrolidone. Dilution with water gives a dispersion.

C) Emulsifiable Concentrates (EC)

15 parts by weight of the active compounds are dissolved in xylene with addition of calcium dodecylbenzenesulfonate and castor oil ethoxylate (in each case 5% strength). Dilution with water gives an emulsion.

D) Emulsions (EW, EO)

40 parts by weight of the active compounds are dissolved in xylene with addition of calcium dodecylbenzenesulfonate and castor oil ethoxylate (in each case 5% strength). This mixture is introduced into water by means of an emulsifying machine (Ultraturrax) and made into a homogeneous emulsion. Dilution with water gives an emulsion.

E) Suspensions (SC, OD)

In an agitated ball mill, 20 parts by weight of the active compounds are comminuted with addition of dispersants, wetters and water or an organic solvent to give a fine active compound suspension. Dilution with water gives a stable suspension of the active compound.

F) Water-Dispersible Granules and Water-Soluble Granules (WG, SG)

50 parts by weight of the active compounds are ground finely with addition of dispersants and wetters and prepared as water-dispersible or water-soluble granules by means of technical appliances (for example extrusion, spray tower, fluidized bed). Dilution with water gives a stable dispersion or solution of the active compound.

G) Water-Dispersible Powders and Water-Soluble Powders (WP, SP)

75 parts by weight of the active compounds are ground in a rotor-stator mill with addition of dispersants, wetters and silica gel. Dilution with water gives a stable dispersion or solution of the active compound.
2. Products to be applied undiluted
   H) Dustable Powders (DP)

5 parts by weight of the active compounds are ground finely and mixed intimately with 95% of finely divided kaolin. This gives a dustable product.

I) Granules (GR, FG, GG, MG)

0.5 part by weight of the active compounds is ground finely and associated with 95.5% carriers. Current methods are extrusion, spray-drying or the fluidized bed. This gives granules to be applied undiluted.

J) ULV Solutions (UL)

10 parts by weight of the active compounds are dissolved in an organic solvent, for example xylene. This gives a product to be applied undiluted.

The active compounds can be used as such, in the form of their formulations or the use forms prepared therefrom, for example in the form of directly sprayable solutions, powders, suspensions or dispersions, emulsions, oil dispersions, pastes, dustable products, materials for spreading, or granules, by means of spraying, atomizing, dusting, spreading or pouring. The use forms depend entirely on the intended purposes; they are intended to ensure in each case the finest possible distribution of the active compounds according to the invention.

Aqueous use forms can be prepared from emulsion concentrates, pastes or wettable powders (sprayable powders, oil dispersions) by adding water. To prepare emulsions, pastes or oil dispersions, the substances, as such or dissolved in an oil or solvent, can be homogenized in water by means of a wetter, tackifier, dispersant or emulsifier. However, it is also possible to prepare concentrates composed of active substance, wetter, tackifier, dispersant or emulsifier and, if appropriate, solvent or oil, and such concentrates are suitable for dilution with water.

The active compound concentrations in the ready-to-use preparations can be varied within relatively wide ranges. In general, they are from 0.0001 to 10%, preferably from 0.01 to 1%.

The active compounds may also be used successfully in the ultra-low-volume process (ULV), it being possible to apply formulations comprising over 95% by weight of active compound, or even to apply the active compound without additives.

Oils of various types, wetters, adjuvants, herbicides, fungicides, other pesticides, or bactericides may be added to the active compounds, even, if appropriate, not until immediately prior to use (tank mix). These agents are typically admixed with the compositions according to the invention in a weight ratio of from 1:10 to 10:1.

The compounds I and II or the mixtures or the corresponding formulations are applied by treating the harmful fungi, the plants, seeds, soils, areas, materials or spaces to be kept free from them with a fungicidally effective amount of the mixture or, in the case of separate application, of the compounds I and II. Application can be carried out before or after infection by the harmful fungi.

The fungicidal action of the compound and of the mixtures can be demonstrated by the following experiments:

The active compounds, separately or jointly, were prepared as a stock solution comprising 0.25% by weight of active compound in acetone or DMSO. 1% by weight of the emulsifier Uniperol® EL (wetting agent having emulsifying and dispersant action based on ethoxylated alkylphenols) was added to this solution, and the mixture was diluted with water to the desired concentration.

Use example—activity against brown spot of rice caused by Cochliobolus miyabeanus, protective application

Leaves of potted rice seedlings of the cultivar “Tai-Nong 67” were sprayed to runoff point with an aqueous suspension of the concentration of active compound stated below. The next day, the plants were inoculated with an aqueous spore suspension of Cochliobolus miyabeanus. The test plants were then placed in climatized chambers at 22-24° C. and 95-99% relative atmospheric humidity for 6 days. The extent of the development of the infection on the leaves was then determined visually.

Evaluation was carried out by determining the percentage of infected leaf area. These percentages were converted into efficacies.

The efficacy (E) is calculated as follows using Abbot's formula:
E=(1−α/β)·100

α corresponds to the fungicidal infection of the treated plants in % and

β corresponds to the fungicidal infection of the untreated (control) plants in %

An efficacy of 0 means that the infection level of the treated plants corresponds to that of the untreated control plants; an efficacy of 100 means that the treated plants are not infected.

The expected efficacies of mixtures of active compounds are determined using Colby's formula [R. S. Colby, Weeds, 15, 20-22, (1967)] and compared with the observed efficacies.

Colby's Formula:
E=x+y−x·y/100
E expected efficacy, expressed in % of the untreated control, when using the mixture of the active compounds A and B at the concentrations a and b
x efficacy, expressed in % of the untreated control, when using the active compound A at the concentration a

y efficacy, expressed in % of the untreated control, when using the active compound B at the concentration b

TABLE A
individual active compounds

| | | Concentration of | Efficacy in % |
|---|---|---|---|
| | | active compound | of the |
| | | in the spray | untreated |
| Example | Active compound | liquor [ppm] | control |
| 1 | control (untreated) | — | (90% infection) |
| 2 | I | 4 | 33 |
| 3 | IIb (fosetyl-Al) | 16 | 0 |
| | | 1 | 0 |

TABLE B
mixtures according to the invention

| | Mixture of | | |
|---|---|---|---|
| | active compounds | | |
| | Concentration | Observed | Calculated |
| Example | Mixing ratio | efficacy | efficacy*) |
| 4 | I + IIb | 67 | 33 |
| | 4 + 1 ppm | | |
| | 4:1 | | |
| 5 | I + IIb | 89 | 33 |
| | 4 + 16 ppm | | |
| | 1:4 | | |

*)efficacy calculated using Colby's formula

The test results show that for all mixing ratios the observed efficacy is higher than that predicted using Colby's formula.

1. A fungicidal mixture for controlling harmful fungi, which mixture comprises
1) the triazolopyrimidine derivative of the formula I 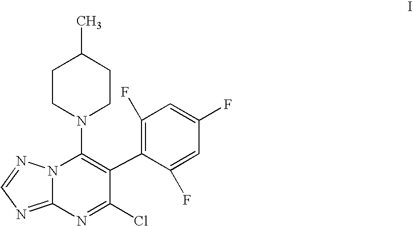
and
2) phosphorous acid H₃PO₃,
its alkali metal or alkaline earth metal salts or derivatives releasing them II
in a synergistically effective amount.

2. The fungicidal mixture according to claim 1 comprising, as compound II, fosetyl aluminum of the formula IIb

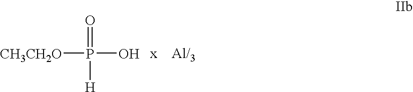

3. The fungicidal mixture according to claim 1 or 2 comprising the compound of the formula I and the compound of the formula II in a weight ratio of from 100:1 to 1:100.

4. A composition comprising a liquid or solid carrier and a mixture according to claim 1.

5. A method for controlling harmful fungi, which comprises treating the fungi, their habitat or the plants, the soil or the seed to be protected against fungal attack with an effective amount of the compound I and the compound II according to claim 1.

6. The method according to claim 5, wherein the compounds I and II according to claim 1 are applied simultaneously, that is jointly or separately, or in succession.

7. The method according to claims 5 or 6, wherein rice-pathogenic harmful fungi are controlled.

8. The method according to claim 5, wherein the mixture according to any of claims 1 to 3 is applied in an amount of from 5 g/ha to 2500 g/ha.

9. The method according to claim 5, wherein the mixture according to any of claims 1 to 3 is applied in an amount of from 1 to 1000 g/100 kg of seed.

10. Seed comprising mixture according to claim 1 in an amount of from 1 to 1000 g/100 kg.

11. The use of one compound I and the compound II according to claim 1 for preparing a composition suitable for controlling harmful fungi.
